(19) United States
(12) Patent Application Publication
(10) Pub. No.: US 2024/0372481 A1
(43) Pub. Date: Nov. 7, 2024

(54) METHOD AND SYSTEM FOR OPERATING A CONTROL TRANSFORMER

(71) Applicant: Maschinenfabrik Reinhausen GmbH, Regensburg (DE)

(72) Inventors: Christian Hammer, Regensburg (DE); Alfred Bieringer, Geiselhoering (DE); Armin Vielhauer, Regensburg (DE)

(21) Appl. No.: 18/563,883

(22) PCT Filed: May 9, 2022
(86) PCT No.: PCT/EP2022/062405

§ 371 Date: Nov. 23, 2023

(30) Foreign Application Priority Data
May 28, 2021 (DE) 10 2021 113 821.3

(51) Int. Cl. H02M 5/10

(52) U.S. Cl. CPC H02M 5/10

(57) ABSTRACT

A method operates a regulating transformer for coupling two electrical energy grids using a system. The system includes: the regulating transformer having a first tap winding on a high-voltage side and a second tap winding on a low-voltage side; a first on-load tap changer that switches between winding taps of the first tap winding; a second on-load tap changer that switches between winding taps of the second tap winding; and a take-off lead connected to the low-voltage side. The method includes: detecting a first signal indicating an imminent transition from a first operating state to a second operating state on the low-voltage side, and actuating the second on-load tap changer such that the second on-load tap changer is switched from a first operating position to a second operating position, in which voltage present on the take-off lead assumes a minimum value.

### CROSS REFERENCE TO RELATED APPLICATIONS

This application is a U.S. National Phase application under 35 U.S.C. § 371 of International Application No. PCT/EP2022/062405, filed on May 9, 2022, and claims benefit to German Patent Application No. DE 10 2021 113 821.3, filed on May 28, 2021. The International Application was published in German on Dec. 1, 2022 as WO 2022/248197 A1 under PCT Article 21(2).

### FIELD

The present disclosure relates to a method for operating a regulating transformer for coupling two electrical energy grids and to a system for operating a regulating transformer for coupling two electrical energy grids.

### BACKGROUND

An electrical energy grid can, for example, be an interconnected grid, an interconnected energy grid, a power grid, an interconnected power grid, an electrical energy grid, an energy supply grid, a power supply grid or an electricity grid.

An electrical energy grid can, for example, assume the function of a transmission grid, a distribution grid, a medium-voltage grid, a low-voltage grid or a feed grid and accordingly transmit energy at extra-high voltage, high voltage, medium voltage or low voltage.

Regulating transformers are variable transformers that change the transmission ratio between their high-voltage side, e.g. a transmission grid operating at 380 kV, and their low-voltage side, e.g. a medium-voltage grid operating at 30 kV. It is thus possible to avoid or compensate for voltage fluctuations resulting from load changes in the energy grid or from energy being fed in from renewable energy systems, for example.

For this purpose, known regulating transformers are equipped, on their high-voltage side, with an on-load tap changer which is designed to switch between winding taps of a tap winding of the transformer without interruption.

Larger photovoltaic (PV) farms generally have a plurality of inverters connected to a feed grid or medium-voltage grid via a multiplicity of distribution transformers, for example via a 33 kV busbar. The feed grid or medium-voltage grid is in turn connected to the distribution grid or transmission grid via a regulating transformer. In order to control the energy supply and to compensate for voltage fluctuations, the regulating transformer usually has an on-load tap changer on the high-voltage side.

Between sunset and sunrise, the PV farm does not generate electrical energy and consequently also does not feed electrical energy into the connected grid. Instead, losses occur as a result of the idle distribution transformers and the cable runs that carry charging current on the PV farm, which then draw energy from the grid rather than feeding it in.

One known method for avoiding these losses is to disconnect the PV farm from the connected energy grid at night. For this purpose, it is known to use circuit breakers, which are connected to the connection between the PV farm, or the busbar to which the PV farm is connected, and the transmission grid and which can interrupt the connection as required. However, disconnection of the busbar by the circuit breaker has the disadvantage that the circuit breaker quickly wears out due to the frequent switching operations, and each time it is switched on there is a so-called inrush to the distribution transformers. In this case, an inrush current flows which can be a multiple of the rated current that will flow later and which can consequently damage the windings and other components of the distribution transformers.

### SUMMARY

In an embodiment, the present disclosure provides a method that operates a regulating transformer for coupling two electrical energy grids using a system. The system includes: the regulating transformer having a first tap winding on a high-voltage side and a second tap winding on a low-voltage side; a first on-load tap changer that switches between winding taps of the first tap winding; a second on-load tap changer that switches between winding taps of the second tap winding; and a take-off lead connected to the low-voltage side. The method includes: detecting a first signal indicating an imminent transition from a first operating state to a second operating state on the low-voltage side, and actuating the second on-load tap changer such that the second on-load tap changer is switched from a first operating position to a second operating position, in which voltage present on the take-off lead assumes a minimum value.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows an advantageous embodiment of a system according to the improved concept in a schematic illustration;

FIG. 2 shows a detailed view of the advantageous embodiment of the system from FIG. 1 in a schematic illustration;

FIG. 3 shows a detailed view of another advantageous embodiment of the system from FIG. 1 in a schematic illustration,;

FIG. 4 shows an advantageous embodiment of the method according to the improved concept; and

FIG. 5 shows another advantageous embodiment of the method according to the improved concept.

### DETAILED DESCRIPTION

The present present disclosure provides an improved concept for the operation of a regulating transformer for coupling two electrical energy grids, by way of which losses caused by the idle operation of a renewable energy system are reduced as much as possible.

According to a first aspect of the improved concept, there is provided a method for operating a regulating transformer for coupling two electrical energy grids, by way of a system for performing the method comprising a regulating transformer having at least one first tap winding on a high-voltage side and having at least one second tap winding on a low-voltage side, a first on-load tap changer for switching between at least two winding taps of the first tap winding, a second on-load tap changer for switching between at least two winding taps of the second tap winding, and a take-off lead connected to the low-voltage side. The method has the following steps: In a first step, a first signal indicating an imminent transition from a first operating state to a second operating state on the low-voltage side of the regulating transformer is detected. In a second step, the second on-load tap changer is actuated in such a way that the second on-load tap changer is gradually switched from a first operating position, in which the voltage present on the take-off lead preferably assumes a maximum value, to a second operating position, in which the voltage present on the take-off lead assumes a minimum value close to zero.

According to the first aspect of the improved concept, there is provided a method for operating a regulating transformer for coupling two electrical energy grids, by way of a system for performing the method comprising a regulating transformer having at least one first tap winding on a high-voltage side and having at least one second tap winding on a low-voltage side, a first on-load tap changer for switching between at least two winding taps of the first tap winding, a second on-load tap changer for switching between at least two winding taps of the second tap winding, a take-off lead connected to the low-voltage side, and also a switching element which is arranged parallel to the second on-load tap changer on the low-voltage side and which can assume an open position and a closed position. The method has the following steps: In a first step, a first signal indicating an imminent transition from a first operating state to a second operating state on the low-voltage side of the regulating transformer is detected. In a next step, the second on-load tap changer is actuated in such a way that the second on-load tap changer is switched from a third operating position to a first operating position, in which the voltage present on the take-off lead preferably assumes a maximum value. Subsequently, the switching element is opened and a current is commutated from the take-off lead to the second on-load tap changer, which is then actuated in such a way that the second on-load tap changer is switched from the first operating position to a second operating position, in which the voltage present on the take-off lead assumes a minimum value close to zero.

According to the improved concept, a first and a second operating state can thus occur on the low-voltage side of the regulating transformer.

In the first operating state, an electrical energy grid arranged on the low-voltage side of the regulating transformer is in a state in which it feeds energy into the electrical energy grid arranged on the high-voltage side of the regulating transformer.

In the second operating state, an electrical energy grid arranged on the low-voltage side of the regulating transformer is in a state in which it does not feed energy into the electrical energy grid arranged on the high-voltage side of the regulating transformer or even draws energy.

According to a preferred embodiment of the improved concept, a renewable energy system, for example a PV farm or a wind turbine, is arranged on the low-voltage side via the take-off lead, which renewable energy system is in an energy-feeding state in the first operating state and in an idle state in the second operating state, that is to say in a non-feeding state.

According to a preferred embodiment of the improved concept, the first signal indicates that a transition from a feeding state to a non-feeding state in a renewable energy system arranged on the low-voltage side is imminent.

According to a preferred embodiment of the improved concept, in the first operating position the second on-load tap changer is in an end position in which the voltage present on the take-off lead assumes a maximum value.

According to a preferred embodiment of the improved concept, in the second operating position the second on-load tap changer is in an end position in which the voltage present on the take-off lead assumes a minimum value close to zero.

According to a preferred embodiment of the improved concept, in the third operating position the second on-load tap changer is in an idle position in which no voltage is present on the take-off lead.

The switching element can be in any form. Preferably, the switching element is in the form of an assembly of the second on-load tap changer, particularly preferably in the form of a change-over selector of the second on-load tap changer. The switching element may also be in the form of a separate assembly and, for example, be in the form of a circuit breaker or load interrupter.

According to a preferred embodiment of the method, the method has the following further steps: In a next step, a second signal indicating an imminent transition from the second operating state to the first operating state on the low-voltage side of the regulating transformer is detected, and subsequently in a further step the second on-load tap changer is actuated in such a way that the on-load tap changer is gradually switched from the second operating position back to the first operating position.

According to a preferred embodiment of the improved concept, the second signal indicates that a transition from a non-feeding state to a feeding state in a renewable energy system arranged on the low-voltage side is imminent.

According to a further preferred embodiment of the method, in a further step the switching element is closed and the on-load tap changer is subsequently actuated in such a way that the second on-load tap changer is switched from the first operating position back to the third operating position.

According to a further embodiment of the method, at least one parameter that is fundamental to a change in the operating state on the low-voltage side of the regulating transformer is detected.

Preferred parameters that are fundamental to a change in the operating state on the low-voltage side are electrical parameters that can be measured on the take-off lead, such as current, voltage, power, reactive power or phase shift. Further, preferred parameters are, for example, a predetermined time period or a daylight-dependent parameter or a wind speed-dependent parameter.

Furthermore, the first signal is output when at least one criterion for the transition from the first to the second operating state is met, and the second signal is output when at least one criterion for the transition from the second to the first operating state is met.

Preferred criteria for the transition from the first to the second operating state and vice versa are a particular current flowing through the take-off lead, a particular voltage present on the take-off lead, or variables derivable therefrom, such as a particular power, reactive power or phase shift. A further criterion is, for example, a predetermined time of day or a predetermined time period that has elapsed. Another possible criterion is a particular light incidence or brightness.

According to a second aspect of the improved concept, a system is also provided.

The features of the system correspond to the steps of the method according to the first aspect of the present disclosure. For the system according to the second aspect of the present disclosure, reference is therefore analogously made to the advantageous explanations, preferred features, technical effects and/or advantages that have already been explained for the method according to the first aspect of the present disclosure. There is no repetition.

In relation to the advantageous configurations of the system that are described below, reference is also analogously made to the explanations, features, method steps, technical effects and advantages that have already been explained for the corresponding embodiments of the method. Here too, there is no similar repetition.

There is provision for a system for operating a regulating transformer for coupling two electrical energy grids. The system comprises a regulating transformer having at least one first tap winding on a high-voltage side and having at least one second tap winding on a low-voltage side, a first on-load tap changer for switching between at least two winding taps of the first tap winding, a second on-load tap changer for switching between at least two winding taps of the second tap winding, a take-off lead connected to the low-voltage side of the regulating transformer, and a control unit. The control unit is designed to detect a first signal indicating a transition from a first operating state to a second operating state on the low-voltage side of the regulating transformer, and to actuate the second on-load tap changer on the basis of the first signal in such a way that the second on-load tap changer is gradually switched from a first operating position, in which the voltage present on the take-off lead preferably assumes a maximum value, to a second operating position, in which the voltage present on the take-off lead assumes a minimum value close to zero.

According to a preferred embodiment of the system, the system also comprises a switching element which is arranged parallel to the second on-load tap changer on the low-voltage side and which can assume an open position and a closed position. According to this embodiment, the control unit is also designed to actuate the second on-load tap changer on the basis of the first signal in such a way that the second on-load tap changer is switched from a third operating position, in which the on-load tap changer is in an idle position, to a first operating position, in which the voltage present on the take-off lead assumes a maximum value, to open the switching element so that a current is commutated from the take-off lead to the second on-load tap changer, and to actuate the second on-load tap changer in such a way that the second on-load tap changer is switched from the first operating position to a second operating position, in which the voltage present on the take-off lead assumes a minimum value close to zero.

According to a further embodiment, the control unit is further designed to detect a second signal describing an imminent transition from the second operating state to the first operating state on the low-voltage side of the regulating transformer, and to actuate the second on-load tap changer on the basis of the second signal in such a way that the second on-load tap changer is gradually switched from the second operating position back to the first operating position.

According to a further embodiment, the control unit is also designed to close the switching element and to subsequently actuate the second on-load tap changer in such a way that the second on-load tap changer is switched from the first operating position to the third operating position.

According to one embodiment, a renewable energy system is connected to the low-voltage side of the regulating transformer via the take-off lead, which renewable energy system generates electrical energy, i.e. is in an energy-feeding state, in the first operating state on the low-voltage side of the regulating transformer, and does not generate electrical energy, i.e. is in a non-energy-feeding state, in the second operating state on the low-voltage side of the regulating transformer.

The renewable energy system is, for example, a PV farm or a wind farm.

According to a preferred embodiment, a load is connected to the low-voltage side of the regulating transformer via the take-off lead, which load draws energy in the first operating state on the low-voltage side of the regulating transformer, and does not draw energy in the second operating state on the low-voltage side of the regulating transformer.

The load can be in the form of an industrial grid or in the form of any energy-drawing component in the grid. For example, the load is an electric drive, a charging facility for electric vehicles, for example one or more fast-charging stations, or a ship terminal in a port for temporarily supplying power to the docked ships.

According to a preferred embodiment, the system comprises an evaluation unit having at least one sensor which is designed to detect at least one parameter that is fundamental to a change in the operating state on the low-voltage side of the regulating transformer.

The evaluation unit is designed to transmit the first signal to the control unit when at least one criterion for the transition from the first to the second operating state is met, and/or to transmit the second signal to the control unit when at least one criterion for the transition from the second to the first operating state is met.

The evaluation unit can be in the form of part of the control unit or in the form of a separate unit.

The at least one sensor can be arranged physically on the evaluation unit and/or can be arranged at a physical distance within the system, for example on the take-off lead.

The at least one sensor can be in the form of an intelligent sensor in such a way that the evaluation unit and the sensor form a common unit which carries out the detection of the parameters as well as the signal processing and signal transmission of the first and second signals to the control unit.

According to one embodiment, the first and/or the second signal are in the form of time-controlled signals. The time-controlled signal is preferably triggered on the basis of the time of day by a timer or in a program-based manner by the control unit, i.e. by a program stored on the control unit. The timer can be integrated in the control unit or in separate form.

According to one embodiment of the system, the regulating transformer comprises a tertiary winding which is designed to independently supply power to electrical equipment, such as alarm systems, telephone systems, lighting systems or safety devices of a renewable energy system, irrespective of the operating state on the low-voltage side of the regulating transformer.

Ensuring the supply of power to electrical equipment from the tertiary winding irrespective of the respective operating state on the low-voltage side of the regulating transformer specifically means that the supply of power to the electrical equipment is ensured when the transition from a first operating state to a second operating state on the low-voltage side takes place and the voltage on the low-voltage side is lowered by the second on-load tap changer.

The improved concept is explained in detail below on the basis of exemplary embodiments with reference to the drawings. Components which are identical or functionally identical or which have an identical effect may be provided with identical reference signs. Identical components or components with an identical function are in some cases explained only in relation to the figure in which they first appear. The explanation is not necessarily repeated in the subsequent figures.

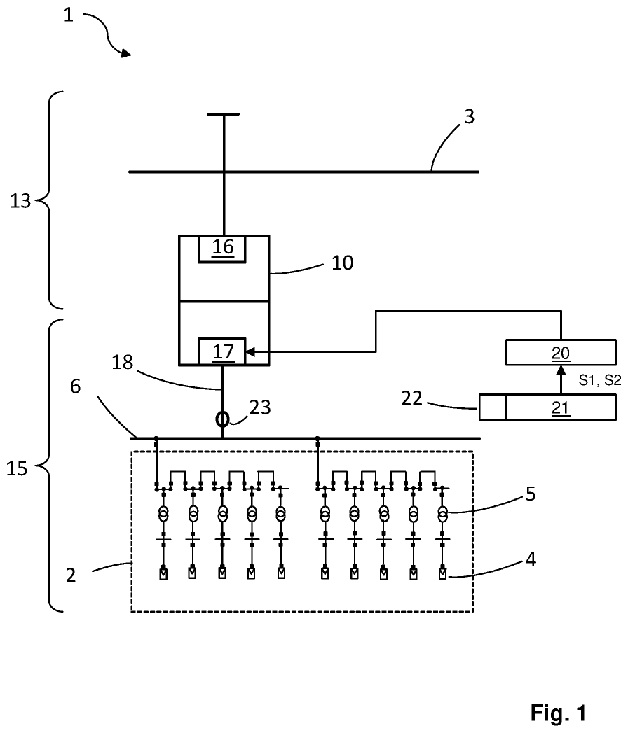

FIG. 1 shows an advantageous embodiment of a system 1 according to the improved concept in a schematic illustration. A PV farm 2 having a plurality of inverters 4 is connected via a multiplicity of distribution transformers 5 to a 33 kV busbar 6, which in turn is connected via a regulating transformer 10 to the 380 kV transmission grid 3. The PV farm 2 is accordingly arranged on a low-voltage side 15 of the regulating transformer 10 and feeds energy into the transmission grid 3, which is arranged on a high-voltage side 13 of the regulating transformer 10. The regulating transformer 10 has, on the high-voltage side 15, a first on-load tap changer 16 for controlling the energy supply and for compensating for voltage fluctuations and, on the low-voltage side 15, a second on-load tap changer 17 for lowering the voltage on the low-voltage side 15 as required, for example at night, when the PV farm 2 does not generate energy. Furthermore, the regulating transformer 10 comprises a take-off lead 18 connected to the low-voltage side 15. The second on-load tap changer 17 is actuated by a control unit 20 (also called a controller herein). The control unit 20 in turn actuates the second on-load tap changer 17 on the basis of the signals S1 and S2 which it receives from an evaluation unit 21 (also called an evaluator herein). For detecting the parameters fundamental to this, the evaluation unit 21 has the sensors 22 and 23. By way of example, sensor 22 is arranged directly on the evaluation unit 21 here and can be in the form of a light sensor, for example. By way of example, sensor 23 is arranged on the take-off lead 18 here and is designed to detect a current flowing through the take-off lead 18, for example.

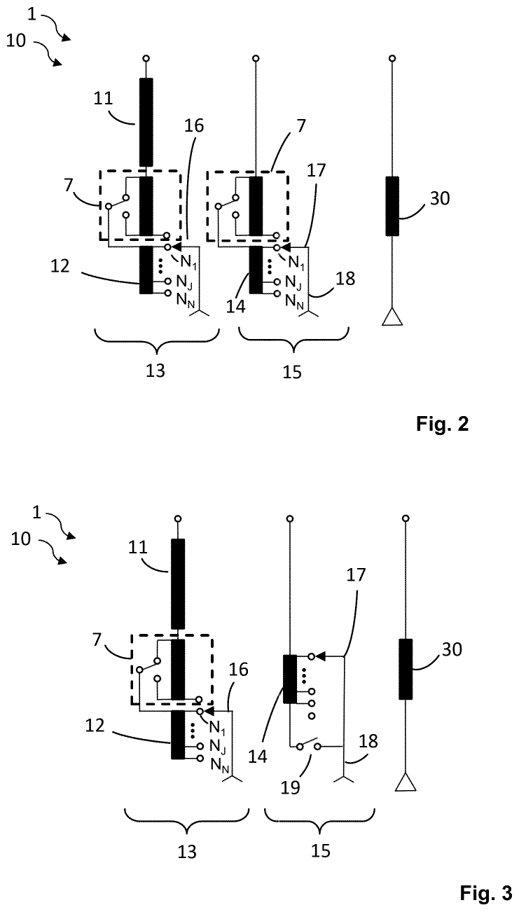

FIG. 2 shows a detailed view of the advantageous embodiment of the system 1 from FIG. 1 in a schematic illustration. The regulating transformer 10 has, on its high-voltage side 13, a main winding 11 and a tap winding 12 having winding taps N₁, . . . N_{J}, . . . , N_{N}, which are connected together by the first on-load tap changer 16. Moreover, the regulating transformer 10 has, on its low-voltage side 15, a second tap winding 14 having winding taps N₁, . . . N_{J}, . . . , N_{N}, which are connected together by the second on-load tap changer 17. Furthermore, the regulating transformer 10 has a tertiary winding 30 which is provided to independently supply power to electrical equipment, such as, for example, alarm systems, telephone systems, lighting systems or safety devices of the PV system 2.

According to this exemplary embodiment, the first and second on-load tap changers 16, 17 each have an additional, so-called coarse tap connection 7 via which a part of the main winding 11 can be switched on or off by the respective on-load tap changer 16, 17.

FIG. 3 shows a detailed view of another advantageous embodiment of the system 1 from FIG. 1 in a schematic illustration. With regard to the system 1 from FIG. 3, reference is analogously made to the preceding explanations with respect to FIG. 2, and only the differences and supplementary features are discussed below. According to the advantageous embodiment shown in FIG. 3, the system 1 additionally has a switching element 19 (also called a switch herein) which is arranged in parallel with the second on-load tap changer 17 on the low-voltage side 15. FIG. 3 illustrates the switching element 19 in an open position, i.e. the current passes through the second on-load tap changer 17.

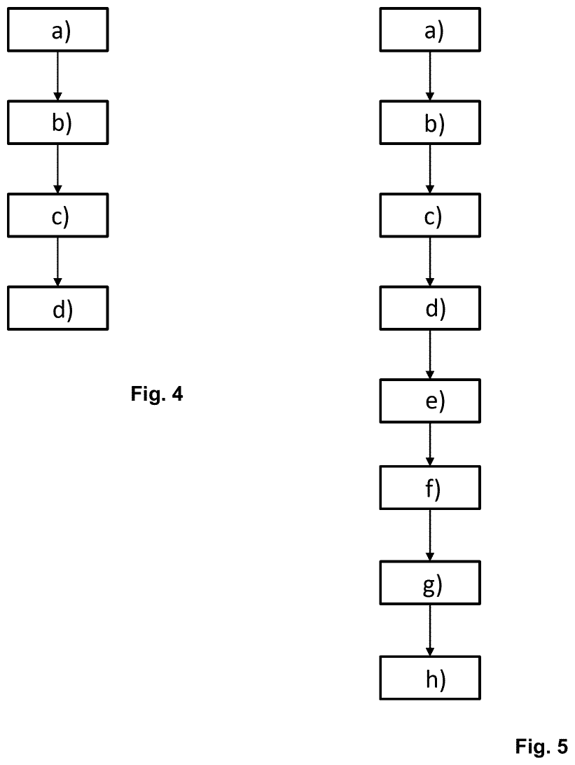

FIG. 4 illustrates an advantageous embodiment of the method according to the improved concept in the form of a flowchart. The method has the following steps:
a) detecting, using the control unit 20, a first signal S1 indicating an imminent transition from a first operating state to a second operating state on the low-voltage side 15 of the regulating transformer 10,
b) actuating, using the control unit 20, the second on-load tap changer 17 in such a way that the second on-load tap changer 17 is switched from a first operating position to a second operating position, in which the voltage present on the take-off lead 18 assumes a minimum value close to zero,
c) detecting, using the control unit 20, a second signal S2 indicating an imminent transition from the second operating state to the first operating state on the low-voltage side 17 of the regulating transformer 10,
d) actuating, using the control unit 20, the second on-load tap changer 17 in such a way that the second on-load tap changer 17 is switched from the second operating position back to the first operating position.

With regard to the method, reference is analogously made to the previous explanations, preferred features, effects and/or advantages that have already been explained for the system 1 in relation to FIGS. 1-3. There is therefore no corresponding repetition.

FIG. 5 illustrates another advantageous embodiment of the method according to the improved concept in the form of a flowchart. This method is performed by way of a system 1 as shown in FIG. 3, for example, and has the following steps:
a) detecting, using the control unit 20, a first signal S1 indicating an imminent transition from a first operating state to a second operating state on the low-voltage side 15 of the regulating transformer 10,
b) actuating, using the control unit 20, the second on-load tap changer 17 in such a way that the second on-load tap changer 17 is switched from a third operating position to a first operating position, in which the voltage present on the take-off lead 18 preferably assumes a maximum value,
c) opening, using the control unit 20, the switching element 19 and commutating a current from the take-off lead to the second on-load tap changer 17,
d) actuating, using the control unit 20, the second on-load tap changer 17 in such a way that the second on-load tap changer 17 is switched from the first operating position to a second operating position, in which the voltage present on the take-off lead 18 assumes a minimum value close to zero,
e) detecting, using the control unit 20, a second signal S2 indicating an imminent transition from the second operating state to the first operating state on the low-voltage side 17 of the regulating transformer 10,
f) actuating, using the control unit 20, the second on-load tap changer 17 in such a way that the second on-load tap changer 17 is switched from the second operating position back to the first operating position,
g) closing the switching element (19), using the control unit 20,
h) actuating, using the control unit 20, the second on-load tap changer 17 in such a way that the second on-load tap changer 17 is switched from the first operating position to the third operating position.

With regard to this method, too, reference is analogously made to the previous explanations, preferred features, effects and/or advantages that have already been explained for the system 1 in relation to FIGS. 1-3. There is therefore no corresponding repetition.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### REFERENCE SIGNS

1 system
2 PV farm
3 transmission grid
4 inverter
5 distribution transformer
6 busbar
7 coarse tap connection
10 regulating transformer
11 main winding
12 first tap winding
13 high-voltage side of 10
14 second tap winding
15 low-voltage side of 10
16 first on-load tap changer
17 second on-load tap changer
18 take-off lead
19 switching element (also called a switch herein)
20 control unit (also called a controller herein)
21 evaluation unit (also called an evaluator herein)
22 sensor
S1 first signal
S2 second signal
N₁, . . . N_{J}, . . . , N_{N} winding taps

1. A method for operating a regulating transformer for coupling two electrical energy grids, by way of a system comprising:
the regulating transformer comprising at least one first tap winding on a high-voltage side and at least one second tap winding on a low-voltage side;
a first on-load tap changer configured to switch between at least two winding taps of the first tap winding;
a second on-load tap changer configured to switch between at least two winding taps of the second tap winding; and
a take-off lead connected to the low-voltage side,
the method comprising:
detecting a first signal indicating an imminent transition from a first operating state to a second operating state on the low-voltage side of the regulating transformer, and
actuating the second on-load tap changer in such a way that the second on-load tap changer is switched from a first operating position to a second operating position, in which voltage present on the take-off lead assumes a minimum value close to zero.

2. A method for operating a regulating transformer for coupling two electrical energy grids, by way of a system comprising:
the regulating transformer comprising at least one first tap winding on a high-voltage side and at least one second tap winding on a low-voltage side;
a first on-load tap changer configured to switch between at least two winding taps of the first tap winding;
a second on-load tap changer configured to switch between at least two winding taps of the second tap winding;
a take-off lead connected to the low-voltage side; and
a switch which is arranged parallel to the second on-load tap changer on the low-voltage side and which is configured to assume an open position and a closed position,
the method comprising:
detecting a first signal indicating an imminent transition from a first operating state to a second operating state on the low-voltage side of the regulating transformer,
actuating the second on-load tap changer in such a way that the second on-load tap changer is switched from a third operating position to a first operating position, in which voltage present on the take-off lead assumes a maximum value,
opening the switch and commutating a current from the take-off lead to the second on-load tap changer, and
actuating the second on-load tap changer in such a way that the second on-load tap changer is switched from the first operating position to a second operating position, in which the voltage present on the take-off lead assumes a minimum value close to zero.

3. The method as claimed in claim 1, the method further comprising:
detecting a second signal indicating an imminent transition from the second operating state to the first operating state on the low-voltage side of the regulating transformer, and
actuating the second on-load tap changer in such a way that the second on-load tap changer is switched from the second operating position back to the first operating position.

4. The method as claimed in claim 3, the method further comprising:
closing the switch, and
actuating the second on-load tap changer in such a way that the second on-load tap changer is switched from the first operating position to the third operating position.

5. The method as claimed in claim 1, wherein:
at least one parameter that is fundamental to a change in the operating state on the low-voltage side of the regulating transformer is detected,
the first signal is output when at least one criterion for the transition from the first to the second operating state is met, and
the second signal is output when at least one criterion for the transition from the second to the first operating state is met.

6. A system for operating a regulating transformer for coupling two electrical energy grids, the system comprising:
the regulating transformer comprising at least one first tap winding on a high-voltage side and at least one second tap winding on a low-voltage side;
a first on-load tap changer configured to switch between at least two winding taps of the first tap winding;
a second on-load tap changer configured to switch between at least two winding taps of the second tap winding;
a take-off lead connected to the low-voltage side of the regulating transformer; and
a controller,
wherein the controller is configured to:
detect a first signal indicating a transition from a first operating state to a second operating state on the low-voltage side of the regulating transformer; and
actuate the second on-load tap changer on the basis of the first signal in such a way that the second on-load tap changer is switched from a first operating position to a second operating position, in which the voltage present on the take-off lead assumes a minimum value close to zero.

7. The system as claimed in claim 6, further comprising:
a switch which is arranged parallel to the second on-load tap changer on the low-voltage side and which is configured to assume an open position and a closed position,
wherein the controller is further configured to:
actuate the second on-load tap changer on the basis of the first signal in such a way that the second on-load tap changer is switched from a third operating position to a first operating position, in which the voltage present on the take-off lead assumes a maximum value,
open the switch so that a current is commutated from the take-off lead to the second on-load tap changer, and
actuate the second on-load tap changer in such a way that the second on-load tap changer is switched from the first operating position to a second operating position, in which the voltage present on the take-off lead assumes a minimum value close to zero.

8. The system as claimed in claim 6, wherein the controller is further configured to:
detect a second signal describing an imminent transition from the second operating state to the first operating state on the low-voltage side of the regulating transformer, and
actuate the second on-load tap changer on the basis of the second signal in such a way that the second on-load tap changer is switched from the second operating position back to the first operating position.

9. The system as claimed in claim 8, wherein the controller is further configured to:
close the switch, and
actuate the second on-load tap changer in such a way that the second on-load tap changer is switched from the first operating position to the third operating position.

10. The system as claimed in claim 6, wherein a renewable energy system is connected to the low-voltage side of the regulating transformer via the take-off lead,
in the first operating state on the low-voltage side of the regulating transformer, the renewable energy system generates electrical energy,
in the second operating state on the low-voltage side of the regulating transformer, the renewable energy system does not generate electrical energy.

11. The system as claimed in claim 6, wherein a load is connected to the low-voltage side of the regulating transformer via the take-off lead,
in the first operating state on the low-voltage side of the regulating transformer, the load draws energy,
in the second operating state on the low-voltage side of the regulating transformer, the load does not draw energy.

12. The system as claimed in claim 6, wherein the system comprises an evaluator comprising at least one sensor, wherein:
the at least one sensor is configured to detect at least one parameter that is fundamental to a change in the operating state on the low-voltage side of the regulating transformer,
the evaluator is configured to transmit the first signal to the controller based upon at least one criterion for the transition from the first to the second operating state is met, and/or
to transmit the second signal to the controller based upon at least one criterion for the transition from the second to the first operating state is met.

13. The system as claimed in claim 6, wherein the first and/or second signal are in the form of time-controlled signals.

14. The system as claimed in claim 6, wherein the regulating transformer comprises a tertiary winding which is designed to independently supply power to electrical equipment irrespective of the operating state on the low-voltage side of the regulating transformer.
